(19) United States
(12) Patent Application Publication
(10) Pub. No.: US 2011/0089840 A1
(43) Pub. Date: Apr. 21, 2011

(54) Ultalow-Power Illumination Method and Apparatus

(76) Inventor: James David Arthur, Oak Ridge, TN (US)

(21) Appl. No.: 12/907,844

(22) Filed: Oct. 19, 2010

Related U.S. Application Data
(60) Provisional application No. 61/279,367, filed on Oct. 20, 2009.

(51) Int. Cl. H05B 37/02

(52) U.S. Cl. 315/149; 315/291

(57) ABSTRACT

An ultra-low power illumination apparatus and method providing a useful, low-level illumination source for highlighting objects, navigating, making beacons, glowing toys, or marking pathways in the dark, that may be operated for months or years from a single battery.

### CROSS-REFERENCE TO RELATED APPLICATIONS

This application claims the benefit of Provisional Patent Application No. 61/279,367, filed Oct. 20, 2009.

### FEDERALLY SPONSORED RESEARCH

Not applicable.

### SEQUENCE LISTING OR PROGRAM

Not applicable.

### BACKGROUND OF THE INVENTION

1. Field Of Invention

This invention generally relates to illumination devices, specifically to a new class of ultra-efficient, unobtrusive, ultra-low-power devices that provide useful illumination at intensity levels far below those used in the prior art.

2. Prior Art

The desire to see in the dark is age-old, and the devices invented to serve that need are many. The ancients used torches, then lanterns and candles. More recently we've used nightlights and phosphorescent glow-in-the-dark devices as dim light sources to locate or make objects visible, or to light or demarcate pathways in the dark.

Nightlights have used either incandescent, neon bulbs, or electroluminescent devices, typical drawing their power from a house's power mains. The most recent nightlights employ LEDs, again operated off mains' power. All of these draw substantial to moderate amounts of power, necessitating the use of mains power, or frequent battery changes for battery-powered units. For example, typical incandescent nightlight bulbs draw 4 watts; LED nightlights examined in retail stores, such as those sold by Leviton Manufacturing Co., Inc, consumed between 0.25 watts for the model 48580-BLU model, and 0.5 watts for most others. None of these units could be reasonably operated from dry cells or common batteries for more than a few days before those dry cells would be drained.

Still another recent device is the solar light, which uses a solar panel to charge a rechargeable cell or battery during the day, then uses the stored energy to light an LED during the night. Solar lights can only be used where sunlight is available, and typically supply their LEDs with currents of 20 mA for several hours each evening before exhausting their batteries.

The instant invention contemplates a plethora of uses and hence an unrecognized need for a long-lived light source that can provide low-level illumination for the purpose of navigating a pathway in the dark, or highlighting and making certain objects, destinations, workspaces, or obstacles plainly visible in the dark, where such device is easy to install or incorporate, small, lightweight, dependable in storms and emergencies when utility power fails, and preferably is easily installed without the need for wires.

Recent advances in light emitting diodes (LEDs), especially in blue and white LEDs, have made it possible to generate low levels of visible light with astonishing efficiencies. For example, at low currents the Nichia NSPW500CS LED's output can exceed 150 lumens per watt. Further, this inventor has found by experiment that blue LEDs using phosphor conversion coatings, such as the NSPW500-type LED, are especially power efficient for low-level illumination, when compared with other LED light sources.

Accordingly it can be seen that the instant invention was not previously possible for want of today's LEDs, nor was the utility of dim illumination recognized in the prior art, in part, in turn, because it was not practicable to produce said dim illumination efficiently.

Further, prior art devices have not distributed their light efficiently by directing it at a particular target. Nightlights, for example, emit light over a large angle, or even omni-directionally. In this way prior art devices have been wasteful of the light they produced, further reducing their overall power efficiencies, and making extended battery operation infeasible.

### SUMMARY OF THE INVENTION

The invention, an ultralow power illumination method and apparatus, combines a power source, a low-level current source, and an LED to provide low-level illumination in a unique and useful way, yet while consuming three orders of magnitude less power than traditional illumination sources. The invention enables a person to see pathways and objects in the dark, illuminated by a device that can operate for months or years from a single battery.

The apparatus is optionally controlled by a light sensor to conserve power when the ambient light levels are high. The ultralow power illumination apparatus may be encased in a case, and that case may be provided with aiming means to facilitate aiming its light emissions at particular target. That case may house a battery of one or more cells, such as a coin cell, to provide power for operating the apparatus. The apparatus' emissions may be focused, concentrating the light it produces efficiently and effectively on a particular target, which further improves brightness without consuming any additional power.

### OBJECTS AND ADVANTAGES

Accordingly several objects and advantages of the invention are to provide highly energy efficient lighting; to make a portable device that can be used in places without power lines; to make a device that can be continuously battery-operated for months or years; and to provide low-level long-lasting illumination that facilitates navigating one's house, garden pathways, basement, bedroom, campsite, tent; or any number of other such tasks conducted in the dark. Further objects and advantages will become apparent from a study of the following description and drawings.

### DRAWINGS

FIG. 1 depicts one battery-operated embodiment of the invention, encased, where the invention is shown adhered to a wall, projecting its light onto a toilet.

FIG. 2 depicts one battery-operated embodiment of the invention, adhered to a mirror, illuminating a vanity.

FIGS. 3A-E depict example mountings and encasements.

FIG. 4 is a mechanical section of the invention's electronic subassembly.

FIG. 5 is a block diagram of one of the invention's preferred circuit embodiments.

FIG. 6 is an electrical schematic diagram of one preferred embodiment of the invention.

### DETAILED DESCRIPTION

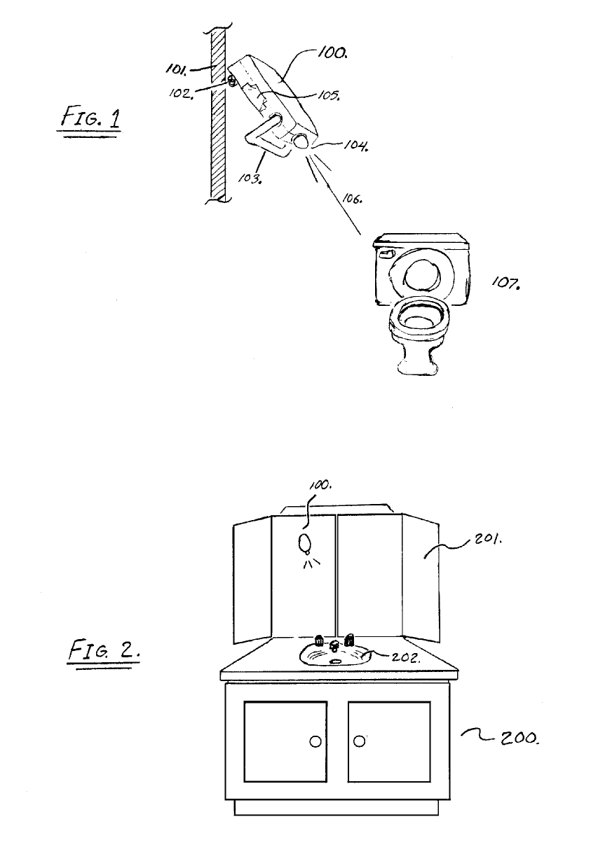

FIG. 1 is a perspective drawing (not to scale) of the illumination apparatus 100., removeably adhered to wall, cabinet, or surface 101. by way of adhesive, tape, or tacky putty 102. (such as HandiTAK, SKU #73754 0040, sold by Super Glue Corp. of Rancho Cucamonga, Calif.). 100.'s attitude may be adjusted via wire arm 103. to direct emissions 106. from light-emitting diode (LED) 104. onto target 107., a toilet.

FIG. 2 is a perspective drawing (not to scale) of the illumination apparatus 100., removeably adhered to mirror 201., directed so as to illuminate sink 202. of vanity 200.

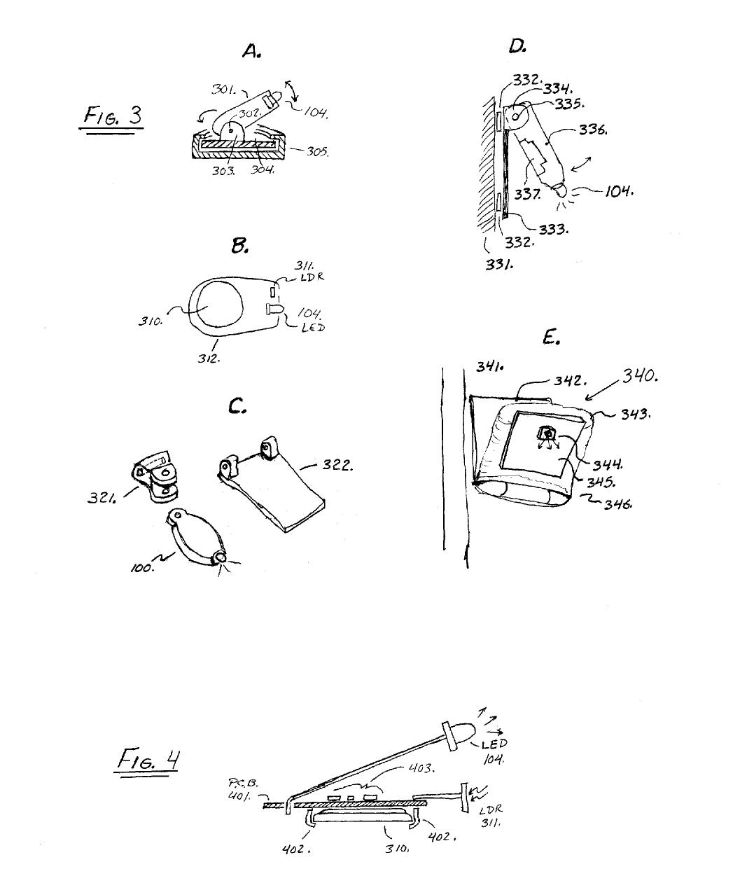

FIG. 3A is a partial cut-away perspective of a 2nd alternative mounting of the invention, where encasement 301. is tiltably mounted on turntable 304. by way of pivot 302., which in turn is joined to tabs 303., which arise from turntable (only one tab 303. is visible from the angle in this rendering).

FIG. 3B is a partial section of a 3rd alternative encasement, wherein housing 312. houses coin cell 310., light-dependent resistor/sensor 311., and LED 104.

FIG. 3C is a perspective rendering of a 4th alternative encasement and mounting, wherein case 100. is secured to hinge piece 321., which in turns mounts to base plate 322. Hinge piece 321. may be joined to base plate 322. by of an axle (not shown). Case 100. may be removeably joined to hinge piece by way of suitably located bumps or protrusions on the exterior of said case 100. which are situated so as to engage corresponding depressions or holes in hinge piece 321. Alternatively, 100. may be joined to hinge piece 321. by way of an axle. (not shown)

FIG. 3D is a side view of a 5th alternative encasement and mounting, wherein housing 336. is mounted to base plate 333. by way of tabs 334., which junction is secured by axle 335. or, alternatively, removeably mounted by matching bumps on case 336. (not visible) engaging holes/depressions 335. Base plate 333. is optionally removeably adhered to surface 331. by adhesive 332. Battery access port 337. permits replacement of spent batteries.

FIG. 3E is a perspective drawing of a sixth alternative encasement enabling the greater use of surface mount construction for ease of manufacturing, wherein this embodiment of the invention 340. is mounted to surface 341. by way of base plate 342. Base plate 342., in turn, is joined to tiltable plate 343. by hinge 346. Tiltable plate 343. supports circuit board 345., which in turn connects to and supports surface mount LED 344. Hinge 346. enables the adjustment and aiming of the emissions of LED 104., over a wide angle, onto a desired target.

FIG. 4 is a side view of one possible electronic sub-assembly of the invention, comprising circuit board 401. bearing circuitry 403., LED 104., light sensor 311., and battery clip(s) 402. Battery clip(s) 402. grip and contact coin cell 310.

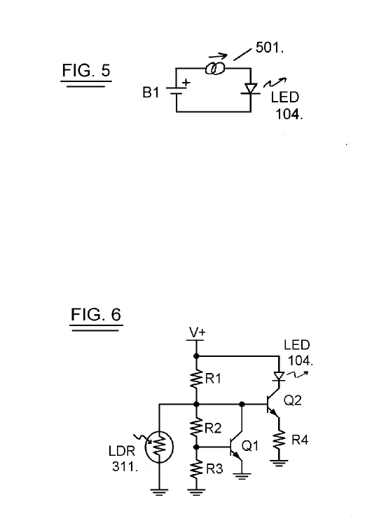

FIG. 5 is an electrical block diagram of the invention, depicting power source B1, connected to current source 501., which in turn is connected to and supplies power to LED 104.

FIG. 6 is a detailed schematic diagram of one preferred embodiment of the invention. Current-source R1-4, Q1-2 supplies LED 104. with a current. To save power and extend battery life, said current is optionally cut off during times of high ambient light by sensor LDR 311., which is depicted here as a light-dependent resistor.

Operation—FIGS. 1-2

FIGS. 1 depicts how my ultralow-power illuminator 100. can be used to dimly illuminate a toilet 107., making it easy to find in the dark. Illuminator 100. is removeably adhered to wall, cabinet, or surface 101. by way of adhesive, tape, or tacky putty 102. (such as HandiTAK, SKU #73754 0040, sold by Super Glue Corp. of Rancho Cucamonga, Calif.). In FIG. 1 the illuminator is pointed in the desired direction by its initial placement, and adjusted via wire arm 103. so that LED 104. shines its light on toilet 107.

In operation, illuminator 100. lights up toilet 107. with an eerie glow that is surprisingly gentle and pleasant; dim, yet sufficient to navigate and function. It's then possible for a person to answer a midnight call of nature without being blinded by harsh, ordinary lighting that jolts one awake and ruins one's night vision, leaving one blind for the trip back to bed. It's also possible for the midnight visitor to detect whether the toilet seat has been left up or down, and avoid the surprises, accidents, and discomfort that can result from misunderstandings about this status.

FIG. 2 shows a generic depiction of my illuminator 100. illuminating a vanity sink 202. Pointing and aiming of illuminator 100. here can be by any number of ways or mechanisms, as is appropriate to the application and the housing and mounting employed.

The usage depicted in FIG. 2 compliments the usage of FIG. 1 by similarly making sink 202. and controls visible, yet without blinding or jarring the patron rudely awake in the dead of night.

Operation—FIGS. 3A-E

The crux of the invention lies in its deliberate use of ultralow illumination levels, low currents, and modern LEDs to produce useful, long-lasting illumination. That being said, there are any number of ways to exploit both the method of using low illumination to some useful purpose, and my apparatus for producing it. Accordingly, the invention's many applications have different needs with respect to mounting and aiming. Accordingly, FIGS. 3A-E depict a series of example cases and mounting features to illustrate the application of the invention to common situations.

FIG. 3A depicts a mounting that can be easily pointed at any object by rotating turntable 304. to the desired direction, then adjusting the height of the illuminator 301. to the desired elevation, pivoting it on pivot 302. This mounting is suitable for use on, for example, a wall or ceiling to illuminate an object or pathway below. Mounted on a wall, higher than a traditional nightlight, the illuminator can be used at a glancing angle to highlight a section of wall or flooring, providing safe navigation in the dark. Used on a floor, this mounting allows the illuminator to illuminate objects at its level or above.

FIG. 3B is a partial section of a 3rd alternative encasement, showing the relative size and placements of coin cell 310., light-dependent resistor/sensor 311., and LED 104.

FIG. 3C shows yet another mounting. Here hinge piece 321. joins illuminator 100. to base plate 322.. In operation, base plate 322. is secured to a mounting surface, then illuminator 100. is pivoted and pointed as desired. As will be apparent to those skilled in the art, the joints connecting 100., 321., and 322 may be fixed by means of pins or axles, or can be fashioned using matching bumps and recesses that illuminator 100. to be removed for servicing, battery replacement, or stand-alone use. Other attachment schemes and mountings and joints will be apparent to those skilled in the art.

FIG. 3D is operated by adhering it to surface 331. with fasteners, adhesive 332., or any other suitable method. Aiming in one axis is possible by pivoting the illuminator's case 336. about pivot 335., adjusting the unit's elevation. Battery access port 337. permits replacement of spent batteries. If desired, pivot 335. can be constructed to allow case 336. to be popped off its mounting for battery replacement.

FIG. 3E depicts yet another case-and-mounting variant, in this case a hinged mounting, demonstrating how the electronic sub-assembly can be assembled completely on the surface of circuit board 345., simplifying high-volume, automated manufacturing of this embodiment. As before, base plate 342. is attached to surface 341. by suitable means. This illumination apparatus 340. is aimed by tilting tiltable plate 343. by way of hinge 346.

Several example enclosures and mountings for the invention are depicted in FIGS. 3A-E, however, any number of constructions are possible, optionally incorporating—but not limited to—gimbals, ball-and socket joints, hinges, post-and-axle, or others, permitting mounting of the invention and adjustment and aiming of the emissions from LED 104. or surface-mount LED 344., as appropriate.

It is further contemplated that simple encasements such as FIG. 3B may be directly adhered to supporting surfaces by way of a mound of tacky putty, allowing aiming of such embodiments without the need for any other mechanical means.

Operation—FIG. 5-6

Referring to FIG. 5, power source B1 supplies power to LED 104. through current source 501., providing a current that causes LED 104. to produce a dim glow comparable to moonlight. Current source 501. serves to limit the flow of said current to obtain extremely long battery life. Current source 501. may optionally be controlled by a light sensor that disables or diminishes LED 104. current when ambient light levels are high, thereby saving battery power (and life) when LED 104.'s emissions are not needed.

An important goal and teaching of the invention is the use of low power, low light levels and of techniques that result in heretofore extraordinary battery lifetimes. For the greatest range and convenience of application, it's further desired that such lifetimes are achieved with the smallest possible batteries, enabling applications that would otherwise require large, awkward batteries.

A further reduction in power consumption over the prior art obtains from the judicious use of the light emitted by LED 104., in that that light is concentrated in a particular direction, and not wastefully spread to no good effect. This concentration of emissions, which can be accomplished with external lenses or reflectors, is also provided naturally and inexpensively by the optical properties of most LED packages, and various beamwidths are offered by the LED manufacturers. It has been found by calculation and experiment that a standard 15-degree LED emission pattern is excellent for many applications, providing a 24-fold increase in brightness over a 360-degree omnidirectional emitter (such as an incandescent bulb), a brightness gain that is achieved without using any additional power.

As an example of one preferred embodiment incorporating these teachings, FIG. 1 illustrates how a tiny unit scarcely an inch long can be made if operated from a common coin cell, such as a CR2032 lithium cell. The next larger cell commonly available, the AAA-sized alkaline cell, is nearly double that length all by itself Further, the alkaline cell has a lower terminal voltage than the lithium cell, requiring either more complicated circuitry to drive LED 104., or multiple cells that would greatly increase the size and weight of the invention, which in turn restricts the number of places where the invention can be suitably attached and unobtrusively deployed.

Therefore, use of the smallest possible power source has great advantages to the utility of the invention. However, a long battery life—both to reduce waste and cost of operation, and to minimize the inconvenience of changing batteries—is also of the essence, requiring that the invention operate a minimum of six months from such a cell, otherwise consumers will reject the invention. A year's operation would be, in fact, considerably better and more appealing.

These goals have been accomplished with the instant invention, and more. The first preferred CR2032 cell has a rated capacity of 225 mA-hours. Therefore, to achieve a year's operation, the maximum average current that can be provided to LED 104. is 26 uA if LED 104. is illuminated 24 hours per day, or 34 uA if fitted with sensor LDR 311. and the invention is cut off for an average of at least six hours per day.

As an alternative to using a single CR2032, two CR2032s could be connected in parallel, or larger cells such as the CR2450 can be used, extending the battery life to in excess of two years, while a battery comprising three AAA alkaline cells could be expected to last more than four years. As a further alternative, where larger batteries are available, the current provided to the LED can be increased proportionally to achieve increased brightness (at the expense of battery longevity).

Referring to FIG. 6, a regulated current of approximately 35 uA, reduced in times of high ambient light, is supplied to LED 104. by use of the following component values:

R1, R3: 2.2 megohms

R2: 1.0 megohms

R4: 3,300 ohms

Q1,Q2: MMBT5089

LED 104: white, Nichia NSPW500DS

LDR 311: generic CdS cell

FIG. 6 provides a detailed schematic drawing of one preferred embodiment. Here, Vbe multiplier Q1-R2-R3 supplies transistor Q2 with a relatively stabilized voltage slightly exceeding Q2's base-emitter turn-on voltage. This causes Q2 to conduct a stabilized current—proportional to that slight excess voltage—through LED 104. In the presence of significant ambient light, optional light sensor LDR 311. pulls Q2's base toward ground, causing Q2 to cut off, and current through LED 104. to be reduced or shut off.

Alternate Current Sources—Pulse-Width Modulation

While FIG. 6 depicts a circuit which provides LED 104. that supplies a continuous ultralow current, pulse-width modulation techniques widely known in the art can equally be used to produce ultralow average currents, by pulsing a higher current at a low duty cycle. This is contemplated, understood, and expressed within current source 501. in FIG. 5. Pulse width modulation may have some advantages in certain situations, such as to efficiently overcome leakage in LEDs that have significant leakage currents. Generally, however, it has been found that this is not necessary, and the economy of simpler embodiments such as depicted in FIG. 6 is currently preferred.

Alternate Current Sources—Pulse-Width Modulated DC-to-DC Converter

It is further and particularly anticipated that an equivalent ultra-low current source can be constructed to operate the invention from lower-voltage power sources, such as one or more alkaline cells, by operating a dc-to-dc converter on a pulse-width modulated, periodic basis. For example, with this description it will be obvious to those skilled in the art that a converter such as described in my Converter For Electronic Flashlight, U.S. Pat. No. 7,154,252, could be periodically gated on for brief intervals, thereby producing a series of current pulses comprising an ultralow average current to LED 104. as taught by the instant invention. I have constructed and deployed prototypes of such units, and consider such current sources to be equally within the scope and spirit of current source 501., and of the instant invention.

Further Objects and Advantages

The invention makes it possible to extract useful lighting from minute amounts of power. The tiny amounts of power required, in turn, enable the use of small, inexpensive batteries, and the construction of tiny, lightweight, inexpensive devices that can be used in all sorts of new places—like on a bathroom wall above the toilet, or in a bedroom above a nightstand—to find things in the dark.

Said invention's use of dim lighting has the further advantages of being sufficient to navigate by without ruining one's dark adaptation, without the necessity of disturbing others by using a traditional light source.

Traditional nightlights, requiring mains-power, cannot be easily located where they are needed, nor aimed efficiently at a particular target, but must be plugged into outlets that are most often found by the floor, making it impossible for a nightlight to shine down and illuminate something advantageously from above.

By contrast, my invention permits locating the light source exactly where it is needed, conveniently, in a case small and light enough to be held in place with a benign adhesive putty that can be easily removed, with no need to drill holes or otherwise damage the mounting surface.

When used to illuminate a toilet, my invention allows the use of the toilet on the darkest night, without the danger of “missing” or falling in, and allows the visitor to return quickly to bed, without being blinded, and in a relaxed condition conducive to easily falling back to sleep.

The ability to locate my invention where it's needed, in turn, allows the use of focusing elements (such as LEDs' inherent optics, or lenses or reflectors) to efficiently focus and direct all of the light produced toward usefully illuminating the desired target. This ability to use fully all of the light produced allows my invention as much as twenty-fold additional energy efficiency over omnidirectional emitters of the prior art, as energy is not wasted in producing light that is ultimately scattered or otherwise unproductive, as is the case with, for example, prior art nightlights.

A further advantage of my invention is that it is less expensive to operate than the prior art, that it is portable when battery-operated, and can be employed in places where mains power is unavailable.

Conclusion, Ramifications, and Scope

The instant invention's recognition of the usefulness of dim lighting, and its solution and teachings of how to achieve such lighting, highly efficiently, with a minimum of power, leads to and lends itself to an entire new field of applications which can't possibly all be listed here.

Therefore, although several and various examples and specifics have been set forth here to illustrate potential uses of my illuminator and illumination method, these should not be construed as limiting the scope of my invention, but merely illustrating some of the presently preferred embodiments of this invention and its application.

For example, in addition to the uses already detailed, I have used my illumination method and apparatus to
backlight a battery-operated clock, making it readable in the dark;
make toys that glow, including a ball;
make portable, long-lasting nightstand lights in the form of toy-shaped figures;
and to make markers that glow in the dark, to be used for guiding or marking a path.

Further, the principles and teachings of my invention might be used to provide an ultra-reliable, long-lasting emergency light source for underground miners, or for household illumination during storms or natural disasters.

Thus, the scope of the invention should be determined by the appended claims and their legal equivalents, rather than by the example given here.

What is claimed is:

1. An ultralow-power illumination apparatus comprising a light emitting diode, a power source, and a current-limiting means capable of providing an average current, where said power source is coupled to said current-limiting means, and said current-limiting means is coupled to said light emitting diode, whereby said average current is applied to said light-emitting diode, causing said LED to produce said illumination.

2. The invention claimed in claim 1, where said power source is a battery of one or more cells.

3. The invention claimed in claim 2, where said average current is less than 100 microamperes.

4. The invention claimed in claim 2, where said average current provides a battery life of said battery of more than 3 months.

5. The invention claimed in claim 4, where said current-limiting means is coupled to ambient light-sensing means, where said ambient light sensing means acts to inhibit said current-limiting means in the presence of ambient light, thereby saving power and extending the life of said battery.

6. The invention claimed in claim 5, where the invention is encased in a case means, where said case means is capable of being supported by a support means, and said case means is capable of being aimed at a target means, whereby said invention is supported by said support means and aimed at said target means, and said target means is illuminated by said invention.

7. The invention of claim 6, where said support means is an interior wall.

8. The invention of claim 6, where said support means is a mirror.

9. The invention of claim 6, where said support means is a cabinet.

10. An ultralow-power illumination apparatus comprising a light emitting diode, a power source, and a current-limiting means capable of providing an average current, where said power source is coupled to said current-limiting means, and said current-limiting means is coupled to said light emitting diode, whereby said average current is applied to said light-emitting diode, causing said LED to produce said illumination, whereby said apparatus may be made visible in the dark.

11. The invention of claim 10, where said average current is less than 100 microamperes.

12. The invention of claim 11, where said illumination apparatus is housed in a toy, whereby said toy is made visible in the dark.

13. The invention of claim 11, where said illumination apparatus is housed in a path marker housing means, whereby said apparatus can provide an illuminated path marker for navigating a path in the dark.

14. A method of ultralow-power illumination comprising the steps of providing power means, light-emitting diode means, current-limiting means capable of limiting a current, mounting and aiming means capable of mounting and aiming an assembly, and connecting said power means to said current-limiting means, and connecting said current-limiting means to said LED, thereby creating an assembly, and mounting said assembly in said mounting and aiming means, whereby a mounted, aimable ultralow-power illumination is produced and may be directed as desired.
